(19) United States
(12) Patent Application Publication
(10) Pub. No.: US 2001/0023690 A1
(43) Pub. Date: Sep. 27, 2001

(54) Saw blade for cutting steel-reinforced structure

(76) Inventors: Chang Hyun Lee, Kyongki-Do (KR); Jong Moo Kang, Suwon (KR)

Correspondence Address: Transnational Enterprises, Inc., Ste 207, 95 Bulldog Blvd., Melbourne, FL, 32901, US

(21) Appl. No.: 09/730,177

(22) Filed: Dec. 5, 2000

(30) Foreign Application Priority Data
Mar. 23, 2000 (KR) 2000-14881

(51) Int. Cl. B28D 1/04

(52) U.S. Cl. 125/13.01; 30/347; 83/835

(57) ABSTRACT

The present invention relates to a saw blade and more particularly to a saw blade for cutting steel-reinforced structures to be used for cutting concrete, blocks or pipes in repairing or mending construction materials.

To this end, the present invention presents a saw blade provided with particulate bearing layers which are attached on both sides of a circular steel disk, the steel disk having an opening at its center for connection with the shaft of a motor-operated tool and the steel disk being attached on its periphery with cutting segments at predetermined intervals, with slits formed between them, and which bearing layers are composed of a continuous ring having a fixed width and being located near the center of the steel disk and a plurality of stream-lined wings disposed outside of said ring at predetermined intervals, the wings extending from the outer edge of the ring toward the periphery of the steel disk.

At this time, the wings are formed in such a manner that the both circular arcs extending substantially radially and defining each wing have either the same or different radius of curvature but have the different centers of curvature so that the wings have gradually increasing local area radially from the central side to the outer periphery of a steel disk.

### FIELD OF THE INVENTION

The present invention relates to a saw blade and more particularly to a saw blade for cutting steel-reinforced structures to be used for cutting concrete, blocks or pipes when repairing or mending structural materials.

Recently saw blades using ultra abrasive are widely used as very useful tools for repairing structures and laying or mending pipes. These saw blades are made through the process in which segment tips made from sintering ultra abrasive or ultra wear-resisting material such as CBN, diamond or the like together with metals are soldered around the circumference of a steel disk by means of laser or brazing based on silver-lead.

Such a saw blade based on ultra abrasive has the advantage of excellent workability because it withstands wear so as to be useful for a long time and is free of risk due to breakage of a saw blade in cutting steel pipes or the like in comparison with the type of saw blade using the segments consisting of SiC abrasive as the main component and other refractory components as auxiliary components.

However, even with such an improved saw blade, because most of the cutting work is carried out in a dry manner without use of cooling water, the heat generated during the cutting work and separated chips impose serious impact on the rigidity of the steel disk of a saw blade.

Particularly the heat generated by the friction between the hard material being cut or ground and the steel disk of a saw blade during cutting operation causes the steel disk to warp, resulting in a so-called wobbling phenomena.

Thus, there appeared modified saw blades in the mean time, wherein as a measure to avoid the above-described wobbling phenomena, circular holes are formed at various positions of a steel disk to reduce the heat generation or to expedite the heat dissipation.

However, the saw blades on which holes are drilled have the active or effective area reduced to the extent corresponding to that of the holes and moreover the wobbling problem due to the friction heat generated between the rest part of a steel disk and the material being cut is not perfectly resolved. Therefore, the still-remaining wobbling phenomenon in the saw blade which is used as a hand tool by an operator reduces cutting straightness to deviate from the intended design and even risks the safety of an operator. as a matter of course, the friction heat would decrease corresponding to the area of the holes, but it is only an initial phenomenon. The large frictional area still remaining on the steel disk of a saw blade in conjunction with gradually increasing use time cannot do much for controlling the wobbling phenomena.

As another type of conventional saw blade, an electrodeposition diamond type saw blade wherein an ultra abrasive like diamond particles is deposited on cutting tips and the side surfaces of a steel disk by electroplating step is also in use.

However, those conventional tools have a common drawback in that the initial cutting performance is good but their service life is not long enough so that they are suited for industrial applications in accordance with the purpose of the present invention.

### SUMMARY OF THE INVENTION

Therefore, the present invention is intended to provide a saw blade wherein, to prevent the above-described wobbling phenomena and expedite the discharge of fine cut chips, the tips are mounted via the process of metal sintering and especially particulate bearing layers are formed from material with a high thermal conductivity and wear resistance and with a low friction coefficient through the process of electroplating or plasma spray coating and are arranged substantially radially on both sides of the circular steel disk from the side of the center to the side of the outer periphery of the disk at regular intervals on the circumference of the disk along the direction of rotation of the saw blade. The material for the particulate bearing layers may be selected from the group of diamond, CBN, Al₂O₃, Zr₂O₃, ZrO₂, WC and SiC.

The particulate bearing layers attached on both sides of a circular steel disk, which disk has an opening at the center and is formed on its periphery with slits at regular intervals, are intended to protect the original circular steel disk from thermal damage by reducing the friction heat generated on the saw blade through reduction of the contacting area of the original steel disk in frictional contact with various kinds of hard material being cut to the extent of the area of steel plate uncovered by the bearing layer and also by enabling rapid heat dissipation.

These particulate bearing layers have an additional object of improving cutting performance without wobbling, enhancing cutting quality and increasing cutting speed by having the function of smoothly re-machining the rough green surface of the material once cut to clean the cut surface and maintain the straight advancing property of a saw blade.

Still another object of the saw blade, particularly of the particulate bearing layers is to guide easy discharge of fine cut or ground chips produced during the operation of a saw blade.

The above-described object is achieved according to the first aspect of the present invention by a saw blade provided with particulate bearing layers which are attached on both sides of a circular steel disk to act as auxiliary cutting or abrasive means, the steel disk having an opening at its center for connection with the shaft of a motor-driven tool and the steel disk being attached on its periphery with (main) cutting segments at predetermined intervals, with slits formed between them, and which bearing layers are composed of a continuous ring having a fixed width and being located near the center of the steel disk and a plurality of stream-lined wings disposed outside of said ring at predetermined intervals, the wings extending from the outer edge of the ring toward the periphery of the steel disk.

At this time, the wings are formed in such a manner that the both circular arcs extending substantially radially and defining each wing have either the same or different radius of curvature but have the different centers of curvature so that the wings have gradually increasing local area radially from the central side to the outer periphery of a steel disk.

As the result, the respective portions of the steel disk sandwiched between adjacent wings are shaped so that their local lateral area may be increased with the radial distance from the center of the steel disk, similarly as in the case of wings.

The above object is also achieved according to the second aspect of the invention by a saw blade, wherein the wing layers are arranged in overlapped and fully aligned manner in position in the thickness direction of the steel disk on the front and back face of the disk just as in the first aspect except that one or more holes are drilled on each pair of wings.

The above object is also achieved according to the third aspect of the invention by a saw blade, wherein the shape and basic arranging principle of wings are the same as in the foregoing two, particularly first aspect, except that the corresponding wing layers are arranged in only partially overlapped manner in position in the thickness direction of the steel disk on the front and back face of the disk.

The above object is also achieved according to the fourth aspect of the invention by a saw blade, wherein the shape and arrangement of wings are the same as in the third aspect except that one or more holes are drilled on the overlapped portion of each pair of wings.

### BRIEF DESCRIPTION OF THE DRAWINGS

FIG. 1 shows the plan view of a saw blade according to the first embodiment of the present invention,

FIG. 2 shows the plan view of a saw blade according to the second embodiment of the present invention,

FIG. 3 shows the plan view of a saw blade according to the third embodiment of the present invention,

FIG. 4 shows the plan view of a saw blade according to the fourth embodiment of the present invention, and

FIG. 5 shows a perspective view of cutting segments mounted on a saw blade in partially cut-off manner.

### DETAILED DESCRIPTION OF THE INVENTION

Some preferred embodiments of the present invention will be described in detail below with regard to the attached drawings.

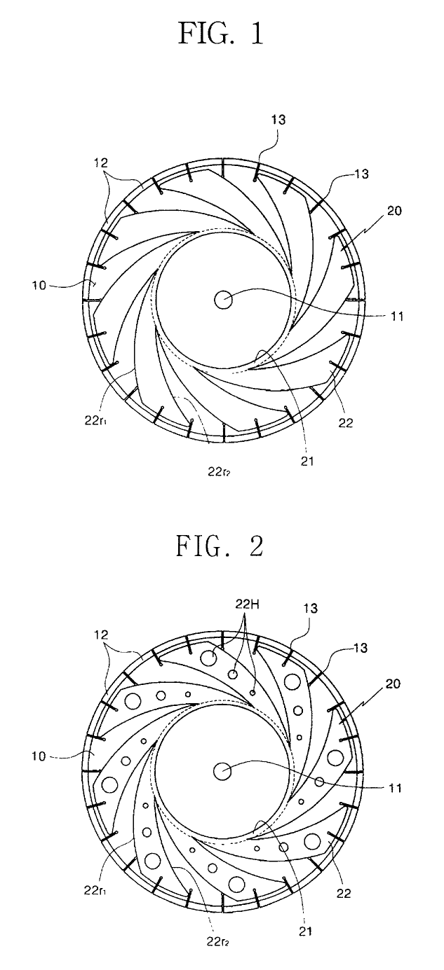

As shown in FIG. 1, which shows the plan view of the saw blade according to the first embodiment of the invention, the steel disk of a saw blade for use for cutting stones or construction materials is attached on its both side surface with one or more kinds of particles selected from the group consisting of diamond, CBN, Al₂O₃, Zr₂O₃, WC, ZrO₂ and SiC by means of the process of electroplating or plasma spray coating.

The saw blade is provided with particulate bearing layers 20 which are attached on both sides of a circular steel disk 10. The circular steel disk 10 has an opening 11 at its center for connection with the shaft of a motor-operated tool and the circular steel disk is attached on its periphery with cutting segments 12 at predetermined intervals, with slits 13 formed between them. And the particulate bearing layer is composed of a continuous ring 21 having a fixed width and being located near the center of the steel disk and a plurality of stream-lined wings 22 disposed around the ring 21 at predetermined intervals. The wings extend from the outer edge of the ring 21 toward the periphery of the circular steel disk 10.

Here, the above-described wings 22 are formed in such a manner that the both circular arcs 22r₁ and 22r₂ extending substantially radially and defining each wing 22 have either the same or different radius of curvature but have the different positions of the center of curvature, with the width between the two arcs increasing with the radial distance from the center of the disk, so that the wings 22 have gradually increasing lateral local area or circumferential width as they approach the outer periphery of a circular steel disk 10. As the result, the respective portions of the steel disk located between adjacent wings 22 or the uncovered portions are also similarly shaped, that is, their local lateral area increases as they get far from the center of the steel disk. This first embodiment is characterized in that the wings of a particulate bearing layer on one face of the circular steel disk are correspondingly overlapped with the wings on the other face of the disk in position in a full and aligned manner.

As is clear, wings having the same shape and size are arranged uniformly over the circumferential surface between the inner ring 21 and the outer periphery of the steel disk 10. This is applied in principle to all of the following embodiments as well.

On the other hand, as shown in FIG. 2, which shows the plan view of the saw blade according to the second embodiment of the invention, the saw blade in this embodiment is just the same as in the first embodiment except that the wings 22 of the particulate bearing layer 20 attached on both side surfaces of the steel disk in full overlapped position are formed with one or more through-holes 22H. In FIG. 2, it is seen that each wing 22 is formed with 3 through-holes 22H with different diameters.

In the case of two or more holes 22H, the holes with the larger diameter are preferably positioned at the wider part of a wing 22. The reason for this is that a higher heat dissipation effect is needed at the peripheral area than at the inner area because more frictional heat is generated at the outer peripheral part due to a higher circumferential velocity during cutting operation.

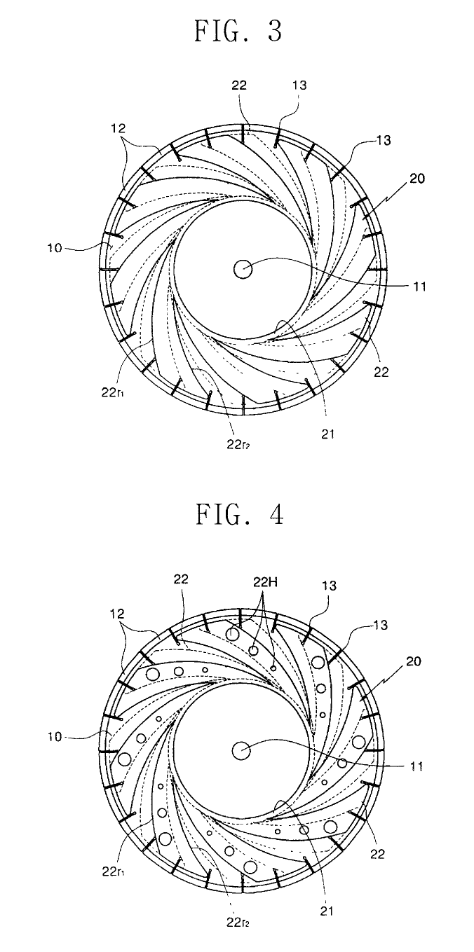

Now referring to FIG. 3, which shows the plan view of the saw blade according to the third embodiment of the invention, the saw blade in this embodiment is constructed in the same way as in the first embodiment except that the corresponding wings 22 on both sides of the original steel disk 10 are not fully overlapped but only partially overlapped in position.

Now referring to FIG. 4, which shows the plan view of the saw blade according to the fourth embodiment of the invention, the saw blade in this embodiment is constructed in the same way as in the third embodiment except that one or more through-holes 22H are formed on the overlapped part of corresponding wings 22.

In any of the above-described embodiments, the steel disk may be made of a single plate or composite plates, for example, two opposite plates sandwiching a third plate for dampening vibration and noise.

It is to be noted that the present invention does not depend on the diameter or laminate structure of the steel disk of a saw blade, the presence or absence of slits on the periphery of a steel disk or the form of segments fixed on the periphery of the steel disk.

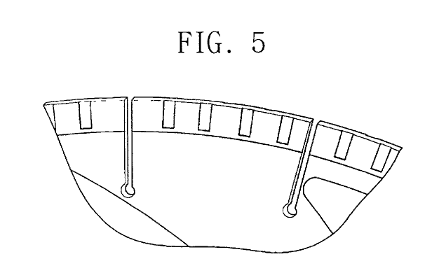

However, as the segment, the turbo-type segment exhibiting planar jig-jag profile due to irregularities on the both sides, as shown in FIG. 5, is preferable, because the fine cut chips or powders which emerged from the passages between the adjacent wings 22 of a particulate bearing layer 20 can be discharged smoothly by virtue of irregularities formed on the both sides of segments.

On the other hand, the following comparative test by the present applicant would demonstrate the performance of the present invention.

A sandwich-type saw blade consisting of circular steel disks with an intermediate copper plate, a saw blade made of an ordinary steel circular disk and a saw blade made of an ordinary steel circular disk but attached with SiC particles having the particle size of #14 on the both sides of the disk to form particulate bearing layers as in FIG. 1 of the invention, all disks having the diameter of 14 inches, were subjected to the test for the deformation of disks and the cutting velocity.

As the result of tests, the sandwich-type saw blade showed minor wobbling phenomena and the ordinary steel saw blade showed intense wobbling phenomena.

On the other hand, the saw blade with SiC particulate bearing layers according to the invention showed no deformation on the steel disk and moreover the increase in cutting velocity by about 20% over the others.

The particulate bearing layers attached on both surfaces of the steel disk according to the first embodiment of the invention include wing sections in helical form at fixed intervals along the circumference of the disk to be suited to the direction of rotation, which wing sections are positioned in full overlapped relation on both surfaces of the steel disk.

As the result, in the first and second embodiments, the first sections in which particulate bearing layers are positioned and which form a thicker portion with a constant thickness as a whole and the second sections with a thinner thickness and consisting of only steel are divided throughout the saw blade. The first sections work as fine-cutting or abrasive surfaces for the work piece to produce fine cut chips or powders and the second sections serve as passages or channels to discharge thus-produced chips toward the periphery of the saw blade. In this way, the maximum proportion of thickest area or firm frictional contact area within the plan of a saw blade can be attained. In this connection, in the cutting operation by using a saw blade according to the first or second embodiment, the lateral shaking of a saw blade due to thickness variation was not observed, apparently because in a given intermittently contacting rotation cycle, the firmly contacting phase is long enough to ensure stable cutting operation.

As the form of wings is curved in compliance with the rotational direction of the saw blade, the ground powders can be guided smoothly outward due to the centrifugal force of the rotating saw blade before they are discharged to the outside.

The generally helical reinforcing wings emerging from the continuous circular reinforcing ring are shaped streamlined to agree with the direction of rotation in such a manner that the exposed area of the steel disk between neighboring particulate wings, as the passage for cut chips, gets larger from the inside to the outer peripheral side of the saw blade. Thus, any fine chips can be smoothly discharged thanks to this rational structure. Because the ring surface 21 of the particulate bearing layer 20 forms a continuous barrier loop, any dust or chips originating from the cutting or abrasive operation of a saw blade are prevented from proceeding to the shaft of the tool (not shown) supporting the saw blade and so those chips or the like can not cause the connected area of the shaft to be worn or damaged. As another important point, the overall particulate bearing layer 20 comprising the ring 21 and wings 22 is an uninterrupted continuous structure and therefore any fine chips resulting from abrasive operation can be guided only radially outward to the peripheral area because of eliminated space for escape or deposition on the disk surface and additionally the same integrated arrangement may help prevent the vibration of the saw blade through uniform contact with the material being cut.

As hinted before, the increase in the area of particulate bearing layer with the radial distance from the center of the saw blade is suited to compensate for the increase in the wear of a saw blade due to a high circumferential velocity at the outer peripheral area by reducing the area of frictional contact through the increase in the area of particulate bearing layer at this region of the saw blade.

The formation of holes 22H on the particulate bearing layer 20 attached on the both opposite surfaces of a steel disk 10 has the advantage of further reducing the friction heat through the reduction in the area of the particulate bearing layer coming into contact with the work piece and at the same time, another advantage of cooling effect due to rapid heat dissipation through the through-holes. Moreover, the hole space also functions to offset the vibration generated between the segment tips attached to the perimeter of a saw blade and the material being cut through interference effect to reduce the vibration of those tips and the generation of noise.

Thus, the particulate bearing layer which is made of ultra wear resisting material like diamond set by sintered metal materials can protect the saw blade as a tool by resisting wear or impact from the hard building material to be cut, guaranteeing a long service life of the tool under smooth and noiseless operation.

As indicated before, because the area of the particulate bearing layer of the saw blade according to the invention is obviously smaller than that of a full circular steel disk, the heat generated by friction is is lessened that much and so can be easily or rapidly removed in combination with favorable construction of the saw blade, whereby the original steel disk is protected from thermal damage.

In addition, the particulate bearing layer according to the invention can increase the cutting speed of the saw blade by smoothly machining or grinding the rough green surface of the material having been cut to clean the cut surface and by maintaining the straight advancing property of a saw blade without wobbling.

It is to be understood that, while the invention was described with respect to some specific embodiments, the invention is not restricted to those embodiments and a variety of modifications and alterations would be possible to a man skilled in the art by referring to the description or drawings presented here and within the spirit of the invention and thus those modifications or alterations are intended to fall within the scope of the invention, which scope should be limited only by the attached claims.

What is claimed is

1. A saw blade for cutting steel-reinforced structural material comprising a steel circular disk (10) having an opening (11) at the center for connection with the shaft of a motor-driven tool, and having cutting segments (12) attached at predetermined intervals along the periphery of the disk, and including the particulate bearing layer on both side surfaces of the disk, the particulate bearing layer being formed from one or more particle materials selected from the group consisting of diamond, CBN, Al₂O₃, Zr₂O₃, ZrO₂, WC and SiC or from other mixed hard particle materials through a process of electroplating or plasma spray coating, the particulate bearing layer comprising circular rings (21) each with a fixed width and positioned in the central area on both side surfaces of the disk (10), and a plurality of streamlined-wings (22) disposed around said rings at predetermined intervals, the wings extending from the outer edge of the ring (21) on each side surface toward the periphery of the circular steel disk (10), wherein the wings (22) on one side (front) surface of the circular steel disk (10) are radially overlapped in position with the wings on the other side (back) surface of the circular steel disk (10).

2. The saw blade according to claim 1, wherein the wings (22) on one side (front) surface of the circular steel disk (10) are overlapped in a full and aligned manner with the wings (22) on the other side (back) surface of the circular steel disk (10).

3. The saw blade according to claim 1 or 2, wherein both circular arcs (22r₁, 22r₂) defining each of the wings (22) have the same or different radius of curvature and have different centers of curvature, said circular arcs extending substantially in radial direction, and said wings (22) are so shaped as to get wider gradually with the radial distance from said ring (21) to the outer periphery of the circular steel disk (10).

4. The saw blade according to claim 1 or 2, wherein the circular steel disk (10) is formed on its outer periphery with a plurality of slits (13) at predetermined intervals.

5. The saw blade according to claim 1 or 2, wherein the segments attached around the periphery of the circular steel disk at predetermined intervals are the turbo-type segments exhibiting planar jig-jag profiles due to irregularities on the both side surfaces of segments.

6. The saw blade according to claim 1 or 2, wherein the portions of wings (22) overlapped in position on both side surf aces of the circular steel disk (10) are formed with one or more through-holes (22H).

7. The saw blade according to claim 6, wherein the plural through-holes (22H) formed on the wings of particulate bearing layers increase in size with the radial distance from the side of the ring (21) to the side of the periphery of the steel disk (10).
